(19) United States
(12) Patent Application Publication
(10) Pub. No.: US 2026/0196124 A1
(43) Pub. Date: Jul. 9, 2026

(54) Alarm System

(71) Applicant: Elbert Brown, Arabi, LA (US)

(72) Inventor: Elbert Brown, Arabi, LA (US)

(21) Appl. No.: 19/015,058

(22) Filed: Jan. 9, 2025

(51) Int. Cl. G08B 25/12; E05B 47/00; G08B 7/06

(52) U.S. Cl. CPC G08B 25/12; E05B 47/0001; G08B 7/06; E05B 2047/0094

(57) ABSTRACT

An alarm system for remotely locking down rooms, or buildings, during an emergency includes a plurality of locks that are coupled to a plurality of doors to secure the plurality of doors in a closed position. A plurality of motors are operatively coupled to the plurality of locks wherein each motor of the plurality of motors is actuatable to engage a respective lock of the plurality of locks. The plurality of motors are actuatable via an electrical signal. A remote control is positionable within each room. Each remote control includes a remote transceiver and a door lock button. The remote transceiver sends the electrical signal to a respective motor of the plurality of motors when the door lock button is actuated.

### (b) CROSS-REFERENCE TO RELATED APPLICATIONS

Not Applicable.

### (c) STATEMENT REGARDING FEDERALLY SPONSORED RESEARCH OR DEVELOPMENT

Not Applicable.

### (d) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### (f) STATEMENT REGARDING PRIOR DISCLOSURES BY THE INVENTOR OR JOINT INVENTOR

Not Applicable.

### (g) BACKGROUND OF THE INVENTION

### (1) Field of the Invention

The disclosure relates to security devices and more particularly pertains to a new security device for remotely locking down rooms, or buildings, during an emergency.

### (2) Description of Related Art Including Information Disclosed Under 37 CFR 1.97 and 1.98.

The prior art relates to security devices. Security devices often include locks for doors, which typically need to be manually engaged while a user is standing within reach of the door. For example, classroom doors in a school building can be locked when someone stands directly in front of the door to manually engage the lock to the classroom door. During an emergency situation, such as a school shooting, this can expose the user who is locking the door to danger because that user is forced to approach a door, and a hallway, where the active shooter may be located. Therefore, there is a need for a security device that allows users to remotely engage a lock to a door during an emergency situation, allowing the users to seek safety instead of forcing users to approach and manually lock the door.

### (h) BRIEF SUMMARY OF THE INVENTION

An embodiment of the disclosure meets the needs presented above by generally comprising a building that has a plurality of doors that provide access to a plurality of rooms. A plurality of locks are coupled to the plurality of doors wherein each lock of the plurality of locks is engageable to secure a respective door of the plurality of doors in a closed position. Each lock of the plurality of locks is an electronic deadbolt wherein each lock of the plurality of locks is configured to be engaged when each lock of the plurality of locks receives an electrical signal. A plurality of motors are operatively coupled to the plurality of locks wherein each motor of the plurality of motors is actuatable to engage a respective lock of the plurality of locks.

A plurality of processors are in communication with the plurality of motors wherein each processor of the plurality of processors is configured to actuate a respective motor of the plurality of motors when each processor of the plurality of processors receives the electrical signal. A plurality of transceivers are in communication with the plurality of processors wherein each transceiver of the plurality of transceivers is configured to send the electrical signal to a respective processor of the plurality of processors.

A plurality of remote controls being positionable within the plurality of rooms wherein an associated remote control of the plurality of remote controls is positionable within the respective room of the plurality of rooms. Each remote control of the plurality of remote controls including a remote processor. A remote transceiver is in communication with the remote processor. The remote transceiver is in wireless communication with a respective transceiver of the plurality of transceivers wherein the remote transceiver is configured to send the electrical signal to the respective transceiver of the plurality of transceivers. A door lock button is in communication with the remote processor wherein the remote transceiver is configured to send the electrical signal to the respective transceiver of the plurality of transceivers to engage the respective lock of the plurality of locks when the door lock button is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an alarm system according to an embodiment of the disclosure.

FIG. 2 is a front view of an embodiment of the disclosure.

FIG. 3 is a front view of an embodiment of the disclosure.

FIG. 4 is a front view of an embodiment of the disclosure.

FIG. 5 is an isometric view of an embodiment of the disclosure.

FIG. 6 is an isometric view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

FIG. 10 is a box diagram view of an embodiment of the disclosure.

### (j) DETAILED DESCRIPTION OF THE INVENTION

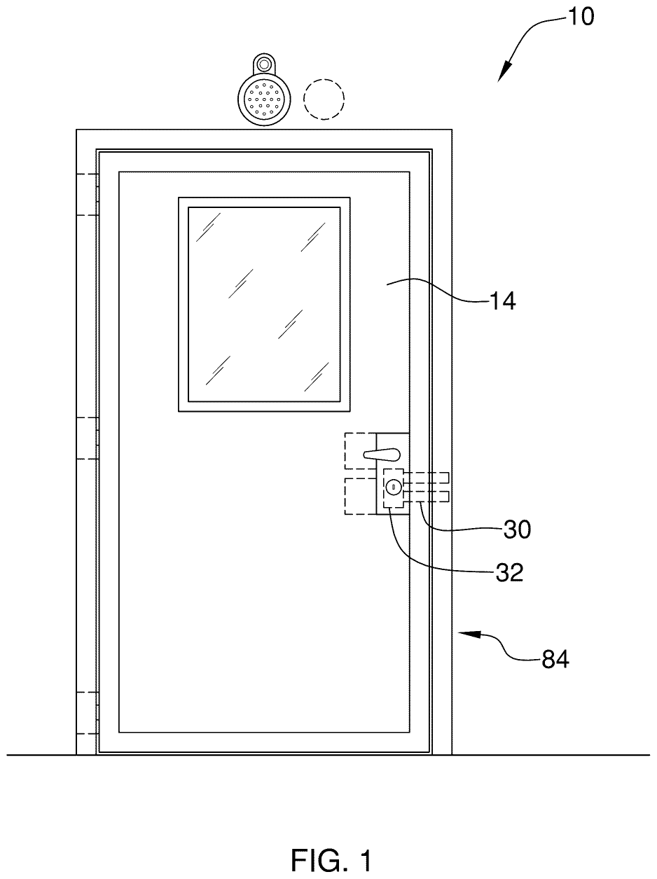

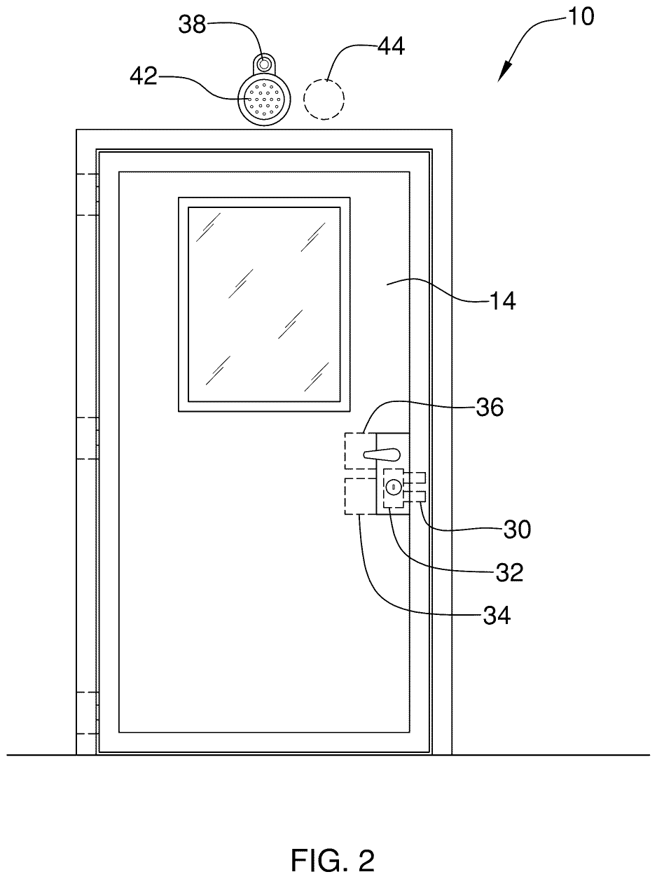

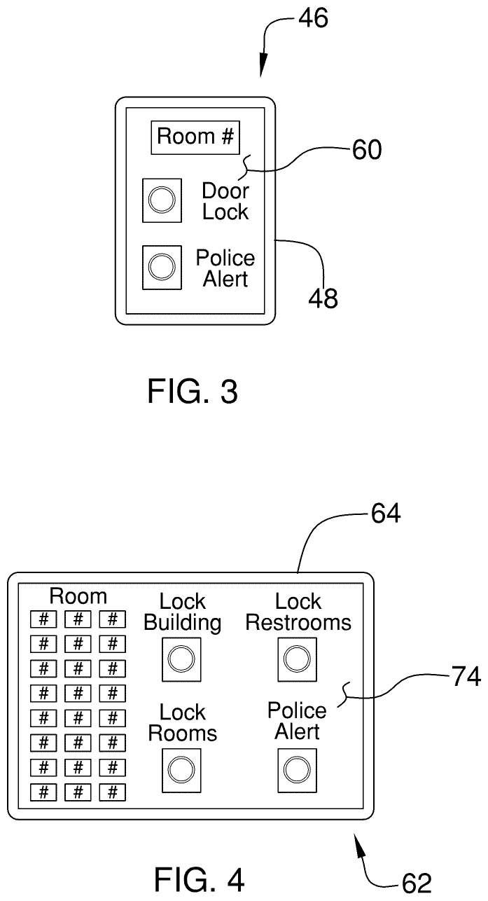

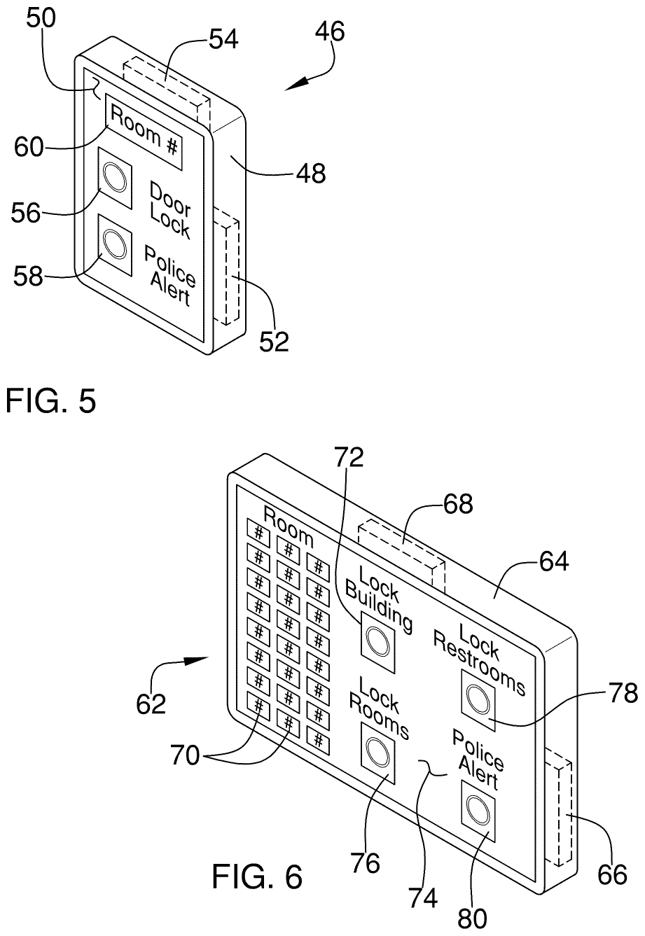

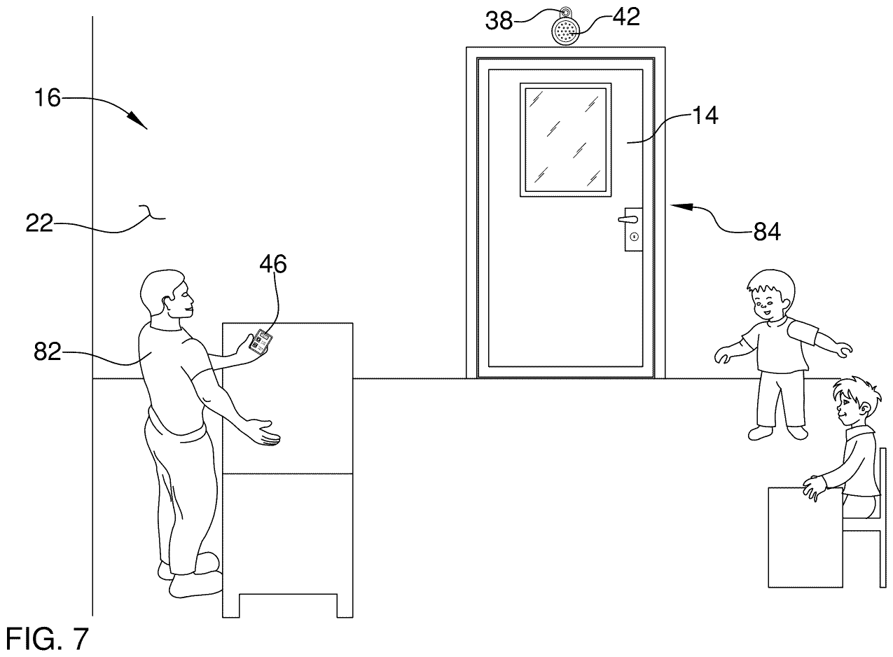

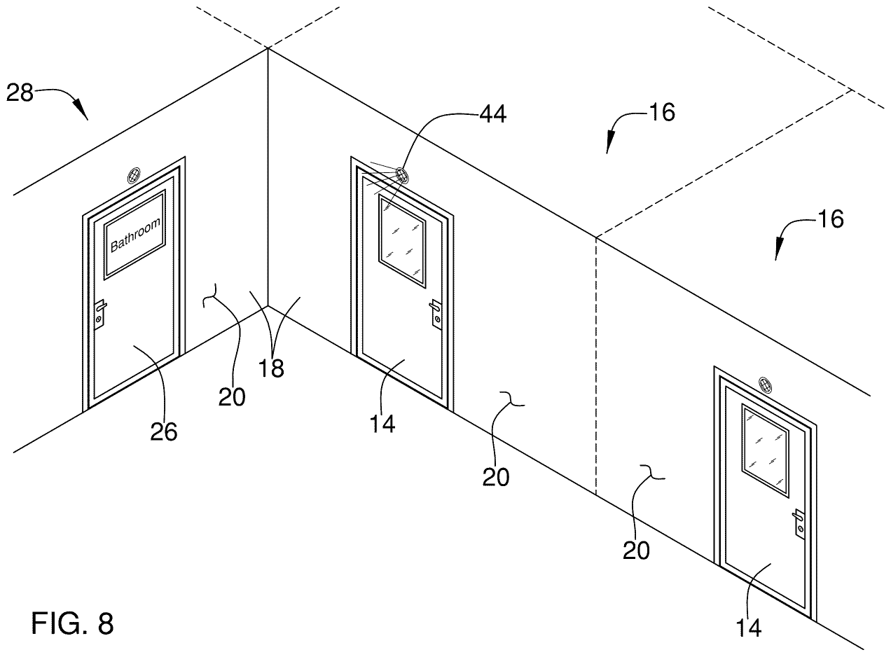

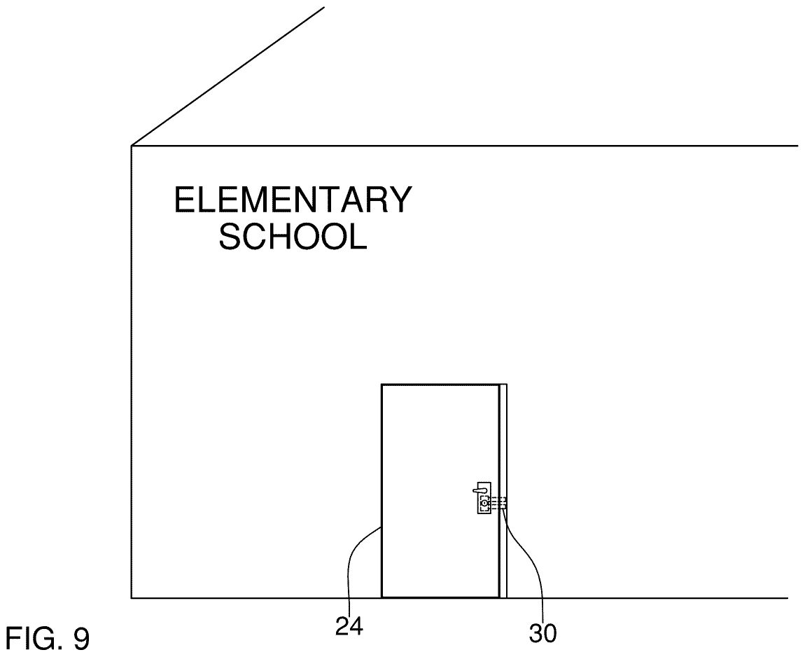

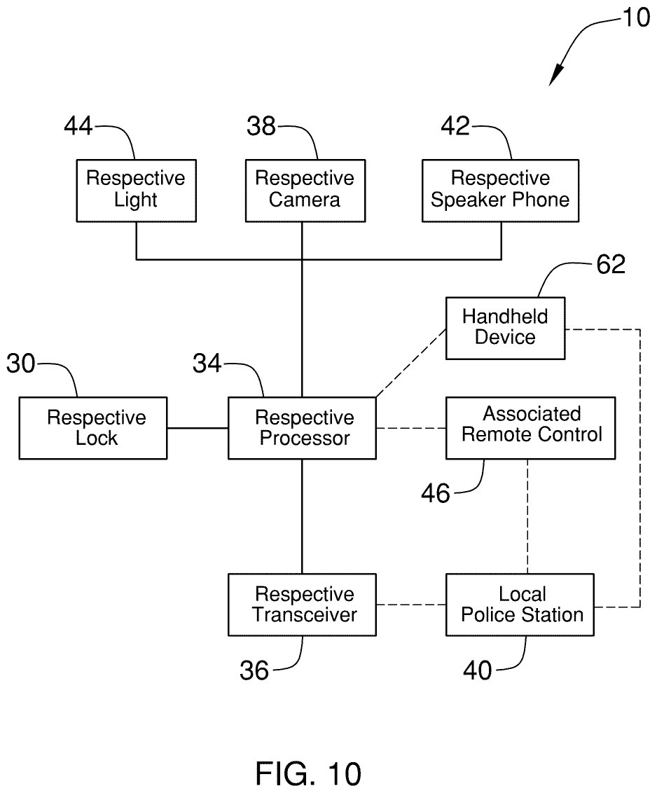

With reference now to the drawings, and in particular to FIGS. 1 through 10 thereof, a new security device embodying the principles and concepts of an embodiment of the disclosure and generally designated by the reference numeral 10 will be described.

As best illustrated in FIGS. 1 through 10, the alarm system 10 generally comprises a building 12 that generally includes a plurality of doors 14 that are openable to provide access to a plurality of rooms 16. Each door of the plurality of doors 14 is positioned on a respective wall of a plurality of walls 18. Each respective wall of the plurality of walls 18 generally includes an outside surface 20 that is positioned outside a respective room of the plurality of rooms 16, and an inside surface 22 that is positioned inside the respective room of the plurality of rooms 16.

For example, the building 12 may be a school, a daycare facility, an office building, a church, a workplace, or other types of buildings, particularly where multiple children are being cared for or multiple people are gathered. Accordingly, the plurality of rooms 16 may include a classroom, a lunchroom, a bathroom, a gym, a storage closet, a conference room, an employee break room, an office, and a muti-purpose room, although other types of rooms are also contemplated. In certain embodiments, each door of the plurality of doors 14 may be bulletproof. Each door of the plurality of doors 14 may also have a thickness that is configured to inhibit each respective door of the plurality of doors 14 from being broken down while the respective door is in a closed position 84. Each door of the plurality of doors 14 may also have reinforced hinges to inhibit each door of the plurality of doors 14 from being broken down while each door of the plurality of doors 14 is in the closed position 84. In certain embodiments, each door of the plurality of doors 14 may also have a respective window, which may be bulletproof.

The building 12 may further include a main entrance 24 that is configured to inhibit access to the building 12 when the main entrance 24 is locked. A bathroom door 26 is configured to inhibit access to a bathroom 28 of the plurality rooms when the bathroom door 26 is locked.

A plurality of locks 30 are coupled to the plurality of doors 14. Each lock of the plurality of locks 30 is engageable to secure a respective door of the plurality of doors 14 in the closed position 84. Each lock of the plurality of locks 30 may be an electronic deadbolt wherein each lock of the plurality of locks 30 is configured to be engaged when each lock of the plurality of locks 30 receives an electrical signal.

A plurality of motors 32 are operatively coupled to the plurality of locks 30. Each motor of the plurality of motors 32 is actuatable to engage a respective lock of the plurality of locks 30. For example, each motor of the plurality of motors 32 may be a rotational motor that rotates the electronic deadbolt into a locked position, as shown in FIG. 1.

A plurality of processors 34 is in communication with the plurality of motors 32. Each processor of the plurality of processors 34 is configured to actuate a respective motor of the plurality of motors 32 when each processor of the plurality of processors 34 receives the electrical signal. Each processor of the plurality of processors 34 may be positioned within the respective door of the plurality of doors 14.

A plurality of transceivers 36 is in communication with the plurality of processors 34. Each transceiver of the plurality of transceivers 36 is configured to send the electrical signal to a respective processor of the plurality of processors 34. Each transceiver of the plurality of transceivers 36 may also be configured to wirelessly communicate with an emergency communications line 40. For example, each transceiver of the plurality of transceivers 36 may be configured to wirelessly communicate with the emergency communications line 40 during an emergency situation, such as an active shooter or hostage situation. The emergency situation generally requires a response from emergency personnel. The emergency communications line 40 may include 911, a local police department's emergency communications line 40, or another emergency contact number. Each transceiver of the plurality of transceivers 36 may be positioned within the respective door of the plurality of doors 14.

A plurality of cameras 38 may be in communication with the plurality of processors 34. Each camera of the plurality of cameras 38 is generally actuatable by a respective processor of the plurality of processors 34. Each camera of the plurality of cameras 38 may be positioned on the inside surface 22 of the respective wall of the plurality of walls 18 on which the respective door of the plurality of doors 14 is positioned. More generally, each camera of the plurality of cameras 38 is configured to record video footage from within the respective room of the plurality of rooms 16. The respective processor of the plurality of processors 34 may be configured to actuate a respective camera of the plurality of cameras 38 when the respective processor of the plurality of processors receives the electrical signal. A respective transceiver of the plurality of transceivers 36 may be configured to send the video footage recorded by the respective camera to the emergency communications line 40. In such embodiments, each camera of the plurality of cameras 38 may be configured to facilitate identification of and response to the emergency situation.

A plurality of speakerphones 42 is in communication with the plurality of processors 34 wherein each speakerphone of the plurality of speakerphones 42 is actuatable by the respective processor of the plurality of processors 34. A speakerphone uses a microphone and a loudspeaker simultaneously, allowing people to talk to and hear each other without a headset or remote control. Several people can hear and be heard in calls between two or more phone lines by using speakerphones.

Each speakerphone of the plurality of speakerphones 42 may be positioned on the respective wall of the plurality of walls 18. For example, each speakerphone of the plurality of speakerphones 42 is positioned adjacent to the respective camera on the inside surface 22 of the respective wall of the plurality of walls 18. More generally, each speakerphone of the plurality of speakerphones 42 is configured to detect an audio feed from within the respective room of the plurality of rooms 16. The respective processor of the plurality of processors 34 may be configured to actuate a respective speakerphone of the plurality of speakerphones 42 when the respective processor of the plurality of processors 34 receives the electrical signal.

The respective transceiver of the plurality of transceivers 36 may be configured to send the audio feed detected by the respective speakerphone of the plurality of speakerphones 42 to the emergency communications line 40. The respective speakerphone of the plurality of speakerphones 42 may also be configured to audibly emit a secondary audio feed from the emergency communications line 40 into the respective room of the plurality of rooms 16 to facilitate conversation between individuals within the respective room and emergency personnel who are outside the respective room during the emergency situation.

A plurality of lights 44 may be electrically coupled to the plurality of processors 34 wherein each light of the plurality of lights 44 is actuatable by a respective processor of the plurality of processors 34. The respective processor of the plurality of processors 34 may be configured to actuate a respective light of the plurality of lights 44 when the respective processor of the plurality of processors 34 receives the electrical signal. The respective light is generally positioned on the outside surface 20 of the respective wall of the plurality of walls 18, for example adjacent to the respective door of the plurality of doors 14. More generally, the respective light of the plurality of lights 44 is configured to provide visual indication of the emergency situation and to identify the respective room of the plurality of rooms 16 in which the emergency situation is occurring. For example, the respective light may visually indicate to emergency personnel and other responders who are outside the respective room to facilitate those individuals in differentiating between the respective room, where the emergency is located, and the other rooms of the plurality of rooms 16.

A plurality of remote controls 46 are positionable within the plurality of rooms 16. An associated remote control of the plurality of remote controls 46 is positionable within the respective room of the plurality of rooms 16. Each remote control of the plurality of remote controls 46 generally includes a body 48. The body 48 may have a size that is configured to be held in a hand of a user 82. The body 48 generally includes a front surface 50.

A remote processor 52 may be positioned within the body 48. A remote transceiver 54 is in communication with the remote processor 52. The remote transceiver 54 is generally in wireless communication with each respective transceiver of the plurality of transceivers 36. The remote transceiver 54 is configured to send the electrical signal to the respective transceiver of the plurality of transceivers 36.

A door lock button 56 is in communication with the remote processor 52. The remote transceiver 54 is configured to send the electrical signal to the respective transceiver of the plurality of transceivers 36 to engage the respective lock of the plurality of locks 30 when the door lock button 56 is actuated. The door lock button 56 may be positioned on the front surface 50 of the body 48 wherein the door lock button 56 is configured to be accessible to the user 82 when the user 82 is holding the body 48 within the hand.

An alert button 58 may be in communication with the remote processor 52. The remote transceiver 54 may be configured to send the electrical signal to the respective transceiver of the plurality of transceivers 36 to actuate the respective camera of the plurality of cameras 38 when the alert button 58 is actuated. The remote transceiver 54 may also be configured to send the electrical signal to the respective transceiver of the plurality of transceivers 36 to actuate the respective speakerphone of the plurality of speakerphones 42 when the alert button 58 is actuated. The respective transceiver of the plurality of transceivers 36 may also be configured to send a notification to the emergency communications line 40 when the alert button 58 is actuated whereby the remote control is configured to facilitate emergency personnel in responding to the emergency situation. The alert button 58 may be positioned on the front surface 50 of the body 48 wherein the alert button 58 is configured to be accessible to the user 82 when the user 82 is holding the body 48 within the hand.

An indicia 60 may be positioned on the body 48, such as the front surface 50 of the body 48. The indicia 60 is generally configured to identify the respective room of the plurality of rooms 16. For example, the indicia 60 may be configured to facilitate the user 82 within the respective room in identifying the respective room while speaking to emergency personnel through the respective speakerphone.

A handheld device 62 may be positionable remotely from the respective room of the plurality of rooms 16. For example, the handheld device 62 may be kept in a front office of the building 12 where the respective room is located. The handheld device 62 may also be carried by a principal of the school or another person of authority within the building 12.

The handheld device 62 generally includes a case 64. The case 64 generally has a size that is configured for the handheld device 62 to be held by a user 82. For example, the case 64 may have a size exceeding a size of the body 48 wherein the body 48 is configured to be operated by a single hand of the user 82 while the case 64 is configured to be held and operated by a pair of hands of the user 82. The case 64 may also be larger than the body 48 because the handheld device 62 generally includes more features and elements than the plurality of remote controls 46. More specifically, the plurality of remote controls 46 are generally designed for use in a single room of the plurality of rooms 16 of the building 12 while the handheld device 62 is generally designed for use in the entire building 12. The case 64 includes a forward surface 74 74.

A main processor 66 may be positioned within the case 64. A main transceiver 68 may be in communication with the main processor 66. The main transceiver 68 is generally in wireless communication with each transceiver of the plurality of transceivers 36. The main transceiver 68 may be configured to send the electrical signal to each transceiver of the plurality of transceivers 36. The main transceiver 68 may also be configured to receive the electrical signal from the respective transceiver of the plurality of transceivers 36 when at least one of the door lock button 56 and the alert button 58 of the associated remote control of the plurality of remote controls 46 is actuated. The main transceiver 68 may also be configured to wirelessly communicate with the emergency communications line 40. The main transceiver 68 may be positioned within the case 64.

A plurality of indicator lights 70 may be electrically coupled to the main processor 66. The main processor 66 may activate a respective indicator light of the plurality of indicator lights 70 when the main transceiver 68 receives the electrical signal from the respective transceiver of the plurality of transceivers 36. More generally, the plurality of indicator lights 70 are configured to visually identify the respective room of the plurality of rooms 16 where the emergency situation is occurring. For example, each indicator light of the plurality of indicator lights 70 may include an associated room identification number to facilitate users in locating the respective room within the building 12. The main processor 66 may activate multiple indicator lights of the plurality of indicator lights 70 when multiple transceivers of the plurality of transceivers 36 send the electrical signal to the main processor 66, indicating that the emergency situation is occurring in multiple rooms if the plurality of rooms 16. The plurality of indicator lights 70 may be positioned on the forward surface 74 of the case 64 wherein the plurality of indicator lights 70 are configured to be visible to the user 82 while the user 82 is holding the case 64.

A building lock button 72 may be in communication with the main processor 66. Actuation of the building lock button 72 is generally configured to lock the main entrance 24 to inhibit access to the building 12. For example, the main entrance 24 may have an electronic deadbolt similar to the respective lock on the respective door into each room of the plurality of rooms 16. The building lock button 72 may be actuated to inhibit a school shooter or other intruder from entering, or exiting, the building 12, thereby inhibiting the school shooter or intruder from either accessing the building 12 or from escaping the building 12 before emergency personnel can respond to the emergency situation. The building lock button 72 may be positioned on the forward surface 74 of the case 64 wherein the building lock button 72 is configured to be actuatable by the user 82 while the user 82 is holding the case 64 and viewing the plurality of indicator lights 70.

A room lock button 76 may be in communication with the main transceiver 68 wherein the main transceiver 68 is configured to send the electrical signal to each transceiver of the plurality of transceivers 36 when the room lock button 76 of the room lock button 76 is actuated. More generally, the room lock button 76 is actuatable to engage each lock of the plurality of locks 30 thereby securing each door of the plurality of doors 14 in the closed position 84. The room lock button 76 may be positioned on the forward surface 74 of the case 64 wherein the room lock button 76 is configured to be actuatable by the user 82 while the user 82 is holding the case 64 and viewing the plurality of indicator lights 70.

A bathroom lock button 78 may be in communication with the main processor 66. Actuation of the bathroom lock button 78 may be configured to lock the bathroom door 26 to inhibit access to the bathroom 28. The bathroom lock button 78 may be positioned on the forward surface 74 of the case 64 wherein the bathroom lock button 78 is configured to be actuatable by the user 82 while the user 82 is holding the case 64 and viewing the plurality of indicator lights 70.

An emergency button 80 may be in communication with the main transceiver 68 wherein the main transceiver 68 is configured to send the electrical signal to each transceiver of the plurality of transceivers 36 to actuate each camera of the plurality of cameras 38 when the emergency button 80 is actuated. The main transceiver 68 may also be configured to send the electrical signal to each transceiver of the plurality of transceivers 36 to actuate each speakerphone of the plurality of speakerphones 42 when the emergency button 80 is actuated. The main transceiver 68 may also be configured to send the notification to the emergency communications line 40 when the alert button 58 is actuated whereby the handheld device 62 is configured to facilitate emergency personnel in responding to the emergency situation. The emergency button 80 may be positioned on the forward surface 74 of the case 64 wherein the emergency button 80 is configured to be actuatable by the user 82 while the user 82 is holding the case 64 and viewing the plurality of indicator lights 70.

The plurality of processors 34 may be configured to audibly emit a warning sound, such as a siren noise, through the plurality of speakerphones 42 to notify individuals within every room of the plurality of rooms 16 of the emergency situation. For example, the main transceiver 68 may signal each respective processor to audibly emit the warning sound through the respective speakerphone of the plurality of speakerphones 42 when at least one of the building lock button 72, the room lock button 76, the bathroom lock button 78, and the emergency button 80 is actuated.

In use, each lock of the plurality of locks 30 can be remotely engaged via either the associated remote control of the plurality of remote controls 46, or the handheld device 62. Thus, the building 12 can be locked down more quickly during the emergency situation than would be possible by engaging each lock of the plurality of locks 30 by hand. The plurality of remote controls 46 and the handheld device 62 also facilitate communication with emergency communication line.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An alarm system comprising:
a building having a plurality of doors that provide access to a plurality of rooms;
a plurality of locks being coupled to the plurality of doors wherein each lock of the plurality of locks is engageable to secure a respective door of the plurality of doors in a closed position, each lock of the plurality of locks being an electronic deadbolt wherein each lock of the plurality of locks is configured to be engaged when each lock of the plurality of locks receives an electrical signal;
a plurality of motors being operatively coupled to the plurality of locks wherein each motor of the plurality of motors is actuatable to engage a respective lock of the plurality of locks;
a plurality of processors being in communication with the plurality of motors wherein each processor of the plurality of processors is configured to actuate a respective motor of the plurality of motors when each processor of the plurality of processors receives the electrical signal;
a plurality of transceivers being in communication with the plurality of processors wherein each transceiver of the plurality of transceivers is configured to send the electrical signal to a respective processor of the plurality of processors; and
a plurality of remote controls being positionable within the plurality of rooms wherein an associated remote control of the plurality of remote controls is positionable within the respective room of the plurality of rooms, each remote control of the plurality of remote controls including:
a remote processor;
a remote transceiver being in communication with the remote processor, the remote transceiver being in wireless communication with a respective transceiver of the plurality of transceivers wherein the remote transceiver is configured to send the electrical signal to the respective transceiver of the plurality of transceivers; and
a door lock button being in communication with the remote processor wherein the remote transceiver is configured to send the electrical signal to the respective transceiver of the plurality of transceivers to engage the respective lock of the plurality of locks when the door lock button is actuated.

2. The alarm system of claim 1, further comprising a plurality of cameras being in communication with the plurality of processors wherein each camera of the plurality of cameras is actuatable by a respective processor of the plurality of processors, each camera of the plurality of cameras being configured to record video footage from within the respective room of the plurality of rooms.

3. The alarm system of claim 2, wherein the respective processor of the plurality of processors is configured to actuate a respective camera of the plurality of cameras when the respective processor of the plurality of processors receives the electrical signal.

4. The alarm system of claim 1, further comprising a plurality of speakerphones being in communication with the plurality of processors wherein each speakerphone of the plurality of speakerphones is actuatable by the respective processor of the plurality of processors, each speakerphone of the plurality of speakerphones being configured to detect an audio feed from within the respective room of the plurality of rooms.

5. The alarm system of claim 4, wherein the respective processor of the plurality of processors is configured to actuate a respective speakerphone of the plurality of speakerphones when the respective processor of the plurality of processors receives the electrical signal.

6. The alarm system of claim 1, further comprising a plurality of lights being electrically coupled to the plurality of processors wherein each light of the plurality of lights is actuatable by a respective processor of the plurality of processors, the respective processor of the plurality of processors being configured to actuate a respective light of the plurality of lights when the respective processor of the plurality of processors receives the electrical signal.

7. The alarm system of claim 6, wherein the respective light of the plurality of lights is positioned outside the respective room of the plurality of rooms.

8. The alarm system of claim 1, each remote control of the plurality of remote controls further comprising an alert button being in communication with the remote processor.

9. The alarm system of claim 1, further comprising a handheld device being positionable remotely from the respective room of the plurality of rooms, the handheld device including:
a main processor; and
a main transceiver being in communication with the main processor, the main transceiver being in wireless communication with each transceiver of the plurality of transceivers wherein the main transceiver is configured to send the electrical signal to each transceiver of the plurality of transceivers.

10. The alarm system of claim 9, wherein the main transceiver is configured to receive the electrical signal from the respective transceiver of the plurality of transceivers when door lock button of the associated remote control of the plurality of remote controls is actuated.

11. The alarm system of claim 9, the handheld device further comprising a building lock button being in communication with the main processor wherein actuation of the building lock button is configured to lock a main entrance to inhibit access to the building.

12. An alarm system comprising:
a building having a plurality of doors that provide access to a plurality of rooms, each door of the plurality of doors being positioned on a respective wall of a plurality of walls, each respective wall of the plurality of walls including:
an outside surface being positioned outside a respective room of the plurality of rooms; and
an inside surface being positioned inside the respective room of the plurality of rooms;
the building further including:
a main entrance being configured to inhibit access to the building when the main entrance is locked; and
a bathroom door being configured to inhibit access to a bathroom of the plurality rooms when the bathroom door is locked;
a plurality of locks being coupled to the plurality of doors wherein each lock of the plurality of locks is engageable to secure a respective door of the plurality of doors in a closed position, each lock of the plurality of locks being an electronic deadbolt wherein each lock of the plurality of locks is configured to be engaged when each lock of the plurality of locks receives an electrical signal;
a plurality of motors being operatively coupled to the plurality of locks wherein each motor of the plurality of motors is actuatable to engage a respective lock of the plurality of locks;
a plurality of processors being in communication with the plurality of motors wherein each processor of the plurality of processors is configured to actuate a respective motor of the plurality of motors when each processor of the plurality of processors receives the electrical signal, each processor of the plurality of processors being positioned within the respective door of the plurality of doors;
a plurality of transceivers being in communication with the plurality of processors wherein each transceiver of the plurality of transceivers is configured to send the electrical signal to a respective processor of the plurality of processors, each transceiver of the plurality of transceivers being configured to wirelessly communicate with an emergency communications line, each transceiver of the plurality of transceivers being positioned within the respective door of the plurality of doors;
a plurality of cameras being in communication with the plurality of processors wherein each camera of the plurality of cameras is actuatable by a respective processor of the plurality of processors, each camera of the plurality of cameras being positioned on the inside surface of the respective wall of the plurality of walls on which the respective door of the plurality of doors is positioned wherein each camera of the plurality of cameras is configured to record video footage from within the respective room of the plurality of rooms, the respective processor of the plurality of processors being configured to actuate a respective camera of the plurality of cameras when the respective processor of the plurality of processors receives the electrical signal, a respective transceiver of the plurality of transceivers being configured to send the video footage recorded by the respective camera to the emergency communications line;
a plurality of speakerphones being in communication with the plurality of processors wherein each speakerphone of the plurality of speakerphones is actuatable by the respective processor of the plurality of processors, each speakerphone of the plurality of speakerphones being positioned on the respective wall of the plurality of walls wherein each speakerphone of the plurality of speakerphones is configured to detect an audio feed from within the respective room of the plurality of rooms, the respective processor of the plurality of processors being configured to actuate a respective speakerphone of the plurality of speakerphones when the respective processor of the plurality of processors receives the electrical signal, the respective transceiver of the plurality of transceivers being configured to send the audio feed detected by the respective speakerphone of the plurality of speakerphones to the emergency communications line, the respective speakerphone of the plurality of speakerphones being configured to audibly emit a secondary audio feed from the emergency communications line into the respective room of the plurality of rooms, each speakerphone of the plurality of speakerphones being positioned adjacent to the respective camera on the inside surface of the respective wall of the plurality of walls;
a plurality of lights being electrically coupled to the plurality of processors wherein each light of the plurality of lights is actuatable by a respective processor of the plurality of processors, the respective processor of the plurality of processors being configured to actuate a respective light of the plurality of lights when the respective processor of the plurality of processors receives the electrical signal, the respective light being positioned on the outside surface of the respective wall of the plurality of walls adjacent to the respective door of the plurality of doors wherein the respective light is configured to provide visual indication of the emergency situation and wherein the respective light is configured to identify the respective room of the plurality of rooms in which the emergency situation is occurring;
a plurality of remote controls being positionable within the plurality of rooms wherein an associated remote control of the plurality of remote controls is positionable within the respective room of the plurality of rooms, each remote control of the plurality of remote controls including:
a body having a size being configured to be held in a hand of a user, the body having a front surface;
a remote processor being positioned within the body;
a remote transceiver being in communication with the remote processor, the remote transceiver being in wireless communication with a respective transceiver of the plurality of transceivers wherein the remote transceiver is configured to send the electrical signal to the respective transceiver of the plurality of transceivers, the remote transceiver being positioned within the body;
a door lock button being in communication with the remote processor wherein the remote transceiver is configured to send the electrical signal to the respective transceiver of the plurality of transceivers to engage the respective lock of the plurality of locks when the door lock button is actuated, the door lock button being positioned on the front surface of the body wherein the door lock button is configured to be accessible to the user when the user is holding the body within the hand; and
an alert button being in communication with the remote processor wherein the remote transceiver is configured to send the electrical signal to the respective transceiver of the plurality of transceivers to actuate the respective camera of the plurality of cameras when the alert button is actuated, the remote transceiver being configured to send the electrical signal to the respective transceiver of the plurality of transceivers to actuate the respective speakerphone of the plurality of speakerphones when the alert button is actuated, the respective transceiver of the plurality of transceivers being configured to send a notification to the emergency communications line when the alert button is actuated whereby the remote control is configured to facilitate emergency personnel in responding to the emergency situation, the alert button being positioned on the front surface of the body wherein the alert button is configured to be accessible to the user when the user is holding the body within the hand; and
an indicia being positioned on the front surface of the body wherein the indicia is configured to identify the respective room of the plurality of rooms; and
a handheld device being positionable remotely from the respective room of the plurality of rooms, the handheld device including:
a case having a size being configured to be held by a user, the case having a forward surface;
a main processor being positioned within the case;
a main transceiver being in communication with the main processor, the main transceiver being in wireless communication with each transceiver of the plurality of transceivers wherein the main transceiver is configured to send the electrical signal to each transceiver of the plurality of transceivers, the main transceiver being configured to receive the electrical signal from the respective transceiver of the plurality of transceivers when at least one of the door lock button and the alert button of the associated remote control of the plurality of remote controls is actuated, the main transceiver being configured to wirelessly communicate with the emergency communications line, the main transceiver being positioned within the case;
a plurality of indicator lights being electrically coupled to the main processor, the main processor activating a respective indicator light of the plurality of indicator lights when the main transceiver receives the electrical signal from the respective transceiver of the plurality of transceivers wherein the plurality of indicator lights are configured to visually identify the respective room of the plurality of rooms, the plurality of indicator lights being positioned on the forward surface of the case wherein the plurality of indicator lights are configured to be visible to the user while the user is holding the case;
a building lock button being in communication with the main processor wherein actuation of the building lock button is configured to lock the main entrance to inhibit access to the building, the building lock button being positioned on the forward surface of the case wherein the building lock button is configured to be actuatable by the user while the user is holding the case and viewing the plurality of indicator lights;
a room lock button being in communication with the main processor wherein the main transceiver is configured to send the electrical signal to each transceiver of the plurality of transceivers when the room lock button of the room lock button is actuated whereby the room lock button is actuatable to engage each lock of the plurality of locks thereby securing each door of the plurality of doors in the closed position, the room lock button being positioned on the forward surface of the case wherein the room lock button is configured to be actuatable by the user while the user is holding the case and viewing the plurality of indicator lights;
a bathroom lock button being in communication with the main processor wherein actuation of the bathroom lock button is configured to lock the bathroom door to inhibit access to the bathroom, the bathroom lock button being positioned on the forward surface of the case wherein the bathroom lock button is configured to be actuatable by the user while the user is holding the case and viewing the plurality of indicator lights; and
an emergency button being in communication with the main transceiver wherein the main transceiver is configured to send the electrical signal to each transceiver of the plurality of transceivers to actuate each camera of the plurality of cameras when the emergency button is actuated, the main transceiver being configured to send the electrical signal to each transceiver of the plurality of transceivers to actuate each speakerphone of the plurality of speakerphones when the emergency button is actuated, the main transceiver being configured to send the notification to the emergency communications line when the alert button is actuated whereby the handheld device is configured to facilitate emergency personnel in responding to the emergency situation, the emergency button being positioned on the forward surface of the case wherein the emergency button is configured to be actuatable by the user while the user is holding the case and viewing the plurality of indicator lights.
